(19) United States
(12) Patent Application Publication
(10) Pub. No.: US 2007/0058723 A1
(43) Pub. Date: Mar. 15, 2007

(54) Adaptively adjusted slice width selection

(76) Inventors: Ashwin Amarapur Chandramouly, Bandavane (IN); Kumar Lava, Bangalore (IN); Raghavan Subramaniyan, Bangalore (IN)

Correspondence Address: MOTOROLA, INC., 1303 EAST ALGONQUIN ROAD, IL01/3RD, SCHAUMBURG, IL, 60196, US

(21) Appl. No.: 11/226,026

(22) Filed: Sep. 14, 2005

(51) Int. Cl. H04N 11/04; H04N 7/12

(52) U.S. Cl. 375/240.18; 375/240.26

(57) ABSTRACT

A video encoder (300) and method (400) for encoding video content that performs providing (402) transform coefficients and associated side information for macroblocks forming part of a frame of a video stream. Next the method processes (403) the transform coefficients and associated side information to obtain entropy coded information for the macroblocks. Slices are formed (404) from the entropy coded information, the slices having slice widths that are adaptively adjusted based upon the non-uniformity of video content of the frame.

### FIELD OF THE INVENTION

The present invention relates generally to a video encoder and a method for encoding video content.

### BACKGROUND

Motion Picture Expert Group (MPEG) is a standard for high quality audio and video compression. The basic idea behind MPEG video compression is to remove spatial redundancy within a video frame and temporal redundancy between video frames. The DCT-based (Discrete Cosine Transform) compression is used to reduce spatial redundancy. Motion-compensation is used to exploit temporal redundancy. The images in a video stream usually do not change much within small time intervals. The idea of motion-compensation is to encode a video frame based on other video frames temporally close to it.

Another compressed video information standard H.264 is mainly intended for video transmission in applications having limited bandwidth or storage capacity (e.g. video telephony or video conferencing over mobile channels and devices), and operates by enhancing coding efficiency and improving network adaptation. The coded video data is transmitted over error prone channels or error free channels.

Video sequences consist of a plurality of pictures. Each picture (also called a frame) consists of pixels. Generally frames are of two types intra frames called I-frames and inter frames called P-frames. The intra frame contains information that is present within the current frame or current picture only. The inter frame contains information related to previous, current and following frames. The inter frames use pseudo differences and hence depend on each other.

For encoding purposes pixels are grouped into Macroblocks (MBs). Generally a Macroblock is the smallest unit of data that contains four 8×8 pixels in Y (luminance) block and two 8×8 pixels in C (chrominance) block. Each 8×8 block is an 8×8 sample array.

The MPEG4/H.264 bit-streams transmit data using a slice structure. Slices are introduced for efficient compression and transmission of video data in error prone channels by limiting the propagation of an error and thus help in better performance when compared to no slice structure. A slice comprises of an integral number of macroblocks. The number of macroblocks in a slice can be a fixed number. This fixed number of macroblocks could be a contiguous row or rows of macroblocks, or it could be a set of non-contiguous macroblocks from a pre-defined group of macroblocks (e.g. Flexible Macroblock Ordering as defined in H.264). Alternatively, a slice can contain a varying integral number of macroblocks with an approximately fixed number of bits. The number of bits in a slice is referred to as the slice width and the Peak Signal to Noise Ratio (PSNR) of a bit-stream is dependent upon the slice width as well as the errors introduced in the channel. In general, the PSNR increases with increased slice width for an error free channel, but it can decrease with increased slice width for error prone channel. It is therefore desirable to select slice widths that can increase video quality for error prone channels that can be measured, for example, by a Peak Signal to Noise Ratio (PSNR) or any other quality measurement metric.

### SUMMARY OF THE INVENTION

According to one aspect of the invention there is provided a video encoder comprising: a transform coder; an entropy encoder with an input coupled to an output of the transform coder; and a packetization module having inputs coupled to outputs of the transform coder and entropy coder, wherein in response to receiving data corresponding to a video stream, the transform coder provides transform coefficients and side information that are processed by the entropy coder to provide entropy coded information, and wherein the entropy coded information and side information are processed by the packetization module to provide macroblocks with an adaptively adjusted variable slice width, the slice width being dependent on non-uniformity of content in said video stream.

According to another aspect of the invention, there is provided a method for encoding video content comprising: providing transform coefficients and associated side information for macroblocks forming part of a frame of a video stream; processing the transform coefficients and associated side information to. obtain entropy coded information for the macroblocks; and forming slices from the entropy coded information, the slices having slice widths that are adaptively adjusted based upon the non-uniformity of video content of the frame.

Suitably, the slice width is adaptively adjusted based on the bit rate of the video content, or macroblock type.

When a macroblock mode is 16×16, 16×8 or 8×16 pixels, then the slice width may be selectively reduced depending on the bit rate or otherwise. When a macroblock mode is 8×8 pixels, then the slice width may be suitably selectively reduced depending on the bit rate or otherwise.

Suitably, when a block mode within a macroblock is 8×4, 4×8 or 4×4 pixels, then the slice width can be selectively reduced depending on the bit rate or otherwise. Also, when a macroblock in an inter slice is coded as intra, then the slice width may be suitably selectively reduced depending on the bit rate. Further, when a macroblock is skipped then the slice width may be selectively increased depending on the bit rate or otherwise.

Suitably, the slice widths may be adjusted based on the macroblock type, macroblock mode and block mode the macroblock type being one of intra, inter or skipped, the macroblock mode being one of 16×16, 16×8, 8×16, or 8×8 pixels and the block mode being one of 8×4, 4×8, and 4×4 pixels. The slice width may be limited by a maximum and minimum value.

### BRIEF DESCRIPTION OF THE FIGURES

In order that the invention may be readily understood and put into practical effect, reference will now be made to exemplary embodiments as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 shows the plot of Peak Signal to Noise Ratio (PSNR) vs bit rate for various MPEG4 slice widths performed on Foreman coded bitstreams;

FIG. 2 shows the graph of PSNR vs bit rate for various Flexible Macroblock Ordering (FMO) Foreman coded bitstreams;

FIG. 3 shows the block diagram of a video encoder in accordance with the invention;

FIG. 4 shows a flowchart illustrating a method for encoding video content;

FIG. 5 shows the graph of PSNR vs bit rate for 150 frames of Foreman Quarter Common Intermediate Format (QCIF) coded data at 15 frames per second with the same fixed slice width being used at all bit rates for the fixed slice width case;

FIG. 6 shows the graph of PSNR vs bit rate for 150 frames of Foreman QCIF coded data at 15 frames per second with the PSNR being substantially identical for fixed and variable slice widths at 0% error by using a different fixed slice width for different bit rates;

FIG. 7 shows the graph of PSNR vs bit rate for 150 frames of mobile QCIF coded data at 15 frames per second with the PSNR being substantially identical for fixed and variable slice widths at 0% error;

FIG. 8 shows the graph of PSNR vs bit rate for 150 frames of mobile QCIF data at 15 Hz coded data at 15 frames per second with the PSNR being substantially identical for fixed and variable slice widths at 0% error, where the minimum variable slice width is 300 bits;

FIG. 9 shows the graph of PSNR vs bit rate for 150 frames of container QCIF data at 15 frames per second with the PSNR being substantially identical for fixed and variable slice widths at 0% error, where the minimum variable slice width is 300 bits; and

FIG. 10 shows the graph of PSNR vs bit rate for 150 frames of Foreman QCIF data at 15 frames per second for different slice widths.

### DETAILED DESCRIPTION

Before describing in detail embodiments that are in accordance with the present invention, it should be observed that the embodiments reside primarily in combinations of method steps and apparatus components related to a video coder and encoding video content. Accordingly, the apparatus components and method steps have been represented where appropriate by conventional symbols in the drawings, showing only those specific details that are pertinent to understanding the embodiment of the present invention so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a method, or coder that comprises a list of elements does not include only those elements but may include other elements not expressly listed or inherent to such methods or encoders. An element proceeded by “comprises . . . a” does not, without more constraints, preclude the existence of additional identical elements in the methods or encoders.

It will be appreciated that the embodiments of the invention described herein may be comprised of one or more conventional processors and unique stored program instructions that control the one or more processors to implement, in conjunction with certain non-processor circuits, some, most, or all of the functions of encoders described herein. The non-processor circuits may include, but are not limited to, a radio receiver, a radio transmitter, signal drivers, clock circuits, power source circuits, and user input devices. As such, these functions may be interpreted as steps of a method to perform encoding. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The instant invention relates to an efficient transmission method for video content considering both error free and error prone channels. The description elaborates the slice width structure for H.264 coded video data. However the scope of the invention is not limited to H.264 coded video data, rather it extends to generalized images or video data. The H.264 video content is transmitted over wireless and wireline packet channels in which the channel conditions vary between error free and error prone channel conditions in an unpredictable manner.

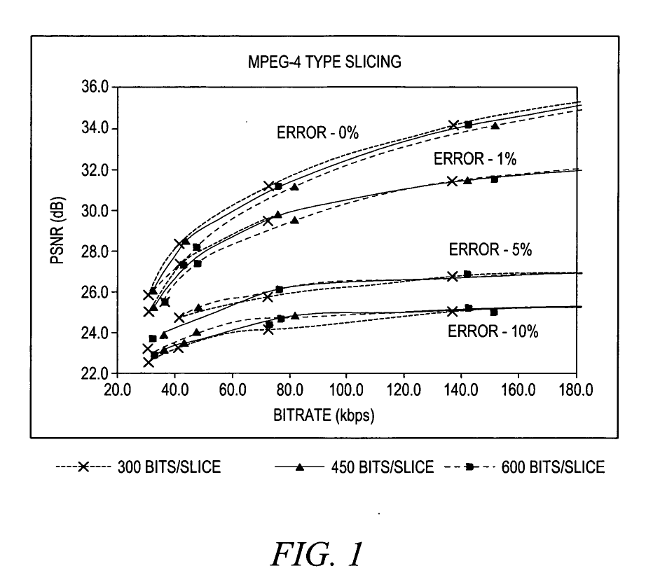

Referring to FIG. 1, there is illustrated Peak Signal to Noise Ratio (PSNR) vs bit rate for various MPEG4 slice widths when transmitted on channels having different error percentages. As illustrated, for the error free channels and low error prone channels, the PSNR is typically lower for a small slice width (e.g. 300 bits/slice) than the PSNR for bit slices widths of 450 and 600 bits. Also, for larger error prone channels (having 5% errors and above) the PSNR is typically higher for a small slice width (e.g. 300 bits/slice). However, it should be noted that there is a tradeoff (more overheads are involved) in terms of compression loss since intra prediction and Motion Vector (MV) prediction uses MBs within the slice only. So for error free channels a slice structure results in an overhead and provides lower performance when compared to a non-slice compression/encoding structure.

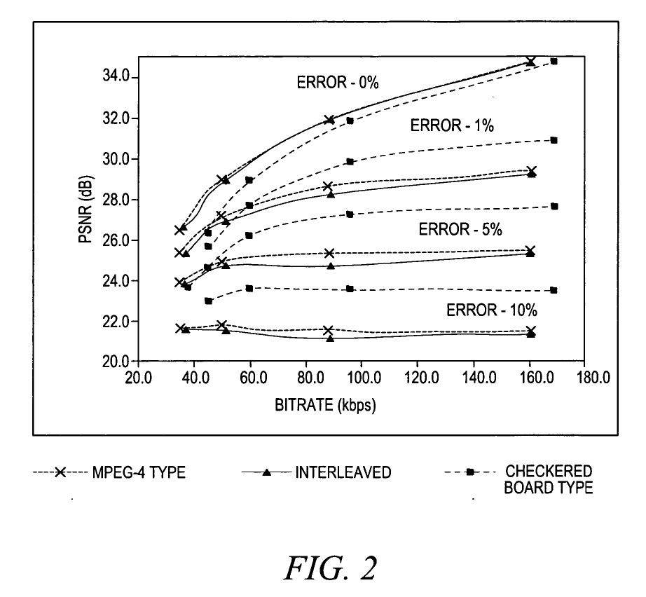

Referring to FIG. 2, there is illustrated Peak Signal to Noise Ratio (PSNR) vs bit rate for Flexible Macroblock Ordering (FMO) when transmitted on channels having different error percentages. As shown, for error prone channels the checkered board type of slicing has a higher PSNR than for Interleaved and MPEG 4 type slicing. Hence, from the above FIGS. 1 and 2 it can be deduced that the selection of the type of slicing and slice width can affect the PSNR of a transmitted bit rate.

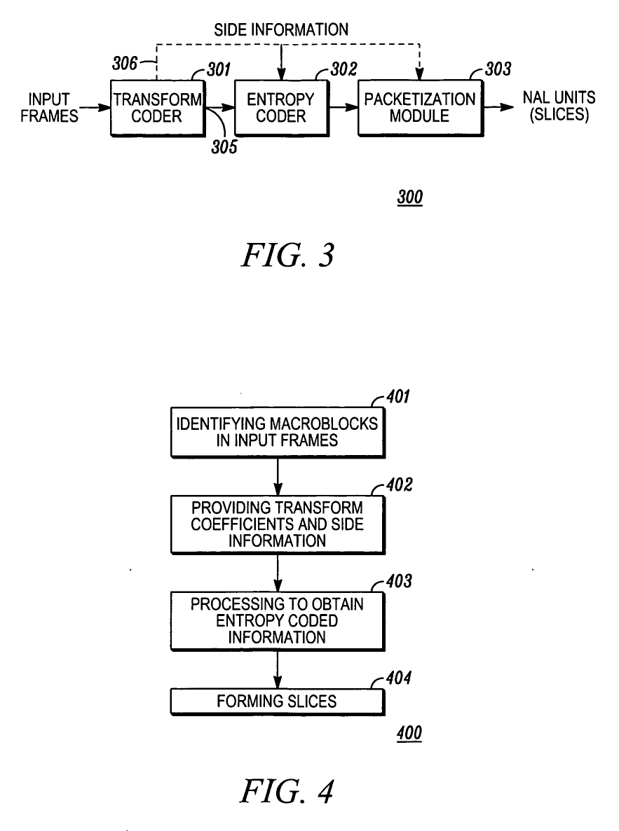

Referring to FIG. 3 there is illustrated a block diagram of a video encoder 300. The encoder comprises a transform coder 301 having an input for receiving input frames to be coded and a first output 305 and second output 306 both connected to respective inputs of an entropy coder 302. The input frames may be, for instance, obtained directly from a camera or from a file. The first output 305 provides transform coefficients of the input frames and the second output provides side information of the input frames. An output of the entropy-coding block 302 is connected to an input of a packetization module 303. The packetization module 303 has another input coupled directly to the second output 306 of the transform coder 301 that provides the side information to the packetization module 303, the provides side information being generated by the transform coder 301. The packetization module 303 has an output that provides slices at its output. In case of H.264 encoder, these slices are referred to as Network Abstraction Layer (NAL) units. In alternative embodiments, variation of the aforesaid video encoder 300 can be used.

The side information generated by transform coding block 301 consists of MB type and Mode information. The side information generally includes encoder settings, modes, tables and the like used for a video sequence, frame, block, macroblock or motion information or quantization step size. The mode information deals with the block size selected for inter/intra coding while the MB type information pertains to different block sizes of MBs being quantized by a macroblock type identifier as described in a latter section.

The transform coder 301 provides side information after coding the input frames for adaptive slice width generation. An example of the transform coder 301 is a DCT based transform coding unit as used in H.264/MPEG4. The output of the transform coder 301 typically provides transform coefficients from inter/intra coding, motion vectors and control information that are supplied to the entropy coder 302. The entropy-coder 302 compresses the data received from the transform coder 301. Generally, arithmetic coding, differential coding, Huffinan coding, run length coding and the like are used as entropy coding techniques depending upon the kind of information (AC/DC coefficients) to be compressed. However other entropy coding techniques can be used. The entropy-coded data is provided to the packetization module 303 and Packetization module 303 forms slices using the bit streams provided by entropy coder 302 and the side information. The width of the slices is varied based on the side information from transform coder 301. An initial slice width can be based on the number of MBs or bits where the number of MB or bits is varied based on the side information. As will be apparent to a person skilled in the art, the side information is indicative of extent of non-uniformity of the video content. The slices so obtained are encoded and transmitted over a channel (or stored in a file for later use) as will be apparent to a person skilled in the art.

The level of non-uniformity is derived based on the modes (block size) of MBs selected for both intra and inter frames. In this specification uniformity refers to areas of a picture/frame that comprise similar pixel values, and non-uniformity refers to areas of a picture/frame that comprise of dissimilar pixel values. For instance, when considering a lakeside picture then the still waters of the lake would be substantially uniform and thus encoded blocks representing regions of the water would be uniform. However, encoded blocks representing regions where the still water meets the lakeshore would be substantially non-uniform.

For non-uniform regions optimal method chooses smaller block sizes for inter and intra frames. A 16×16 MB consists of four Y blocks and two C blocks. Each of the blocks contains 8×8 pixels as will be apparent to a person skilled in the art. Combination of these blocks constitutes different block sizes of a MB that correlates to the degree of non-uniformity of video content.

The P-frame (inter frame) is made of two types of MBs namely I MBs and P MBs. I MBs are like MBs in I frame (intra frame). The P MBs signify a predictive base and encode the difference. However if a P-macroblock has no appreciable difference to encode with respect to its predictive base then MB can be skipped. In MPEG-4 such an MB would have a [0,0] absolute motion vector. In H.264, it would have a [0,0] differential motion vector.

For a P MB, the MB can be encoded in several macroblock modes: 16×16, 16×8, 8×16, and 8×8. This refers to the geometrical partitioning of the P MB for the purpose of encoding. For the case of 8×8 mode, the P MB comprises of four 8×8 blocks. Each of these 8×8 blocks can further be encoded in several block modes: 8×8, 8×4, 4×8 and 4×4. Again, the block modes refer to the geometrical partitioning of the 8×8 block.

Based on the macroblock type, macroblock mode and block mode, the MB are categorized into 5 groups by a macroblock group identifier as follows:

i) P MBs encoded with modes 16×16, 16×8 and 8×16 pixels;

ii) P MBs encoded with mode of 8×8 pixels only;

iii) P MBs with macroblock mode of 8×8 pixels, and with at least one of the 8×8 block types being one of 8×4, 4×8 and 4×4 pixels;

iv) I MBs in p-frame; &

v) Skipped MBs.

Note that this grouping is a preferred embodiment of the invention. Other groupings can be done without deviating from the essence of the invention.

As will be apparent to a person skilled in the art, a slice limits the propagation of an error as it contains additional redundancy provided via coding. Basically, a slice comprises of an integral number of macroblocks. The number of macroblocks in a slice can be a fixed number. This fixed number could be a contiguous row or rows of macroblocks, or it could be a set of non-contiguous macroblocks from a pre-defined group of macroblocks. Alternatively, a slice can contain a varying integral number of macroblocks with an approximately fixed number of bits. The number of bits in a slice is defines the slice width. One of the main challenges in selecting a slice of desired slice width is to enable encoder 300 to achieve a suitable trade-off between error-resilience and compression. The reason is that some video coder applications have to overcome significant amount of packet loss and/or bit errors, and therefore place a high premium on error resilience while other applications may require efficient compression.

In the present invention, the slice width is typically varied based upon the video content in H.264. The video content is divided into plurality of frames/ pictures having non-uniformity. The slice width is chosen based on the aforesaid non-uniformity of the region within the frame. Since the loss of non-uniform regions results in higher loss of PSNR when compared to uniform regions for the same region width, the effect of loss of non-uniform regions is minimized. The slice width is varied depending upon whether region is uniform or non uniform. The slice width for non-uniform regions is decreased.

FIG. 4 shows a flowchart illustrating a method 400 for encoding video content in the form of the input frames provided at the input of the transform coder 301 in which slice width of the encoded video content is adaptively adjusted (selected) based upon the non-uniformity of regions of the input frames. The level of non-uniformity is derived based on the modes (block size) of MBs selected for both intra and inter frames. For non-uniform regions, the method 400 chooses smaller block sizes for inter and intra frames. In this embodiment, a maximum sized MB is 16×16 pixels and consists of four Y blocks and two C blocks, where each of these blocks contains 8×8 pixels. Combination of these blocks constitutes different block sizes of a MB that correlates to the degree of non-uniformity of video content.

The method 400 commences with identifying macroblocks MBs 401 in input frames containing video content, each of the input frames being a picture frame of pixels, that can be grouped together to form MBs. The identified macroblocks MBs are transformed into transform coefficients with the associated side information by the transform coder 301 at a providing transform coefficients block 402. Transform coding techniques including DCT based transform coding can be employed for providing the transform coefficients.

The transform coefficients and associated side information are processed at block 403 by the entropy coder 302 using known entropy-coding techniques to obtain entropy coded information relating to the MBs. A process at block 404 provides for forming slices from the entropy coded information. The slices have slice widths that are adaptively adjusted based upon the non-uniformity of video content of a frame by adaptively adjusting their slice widths by packetization module 303. The slice adaptively adjusted slice width is dependent on a bit rate threshold value BTHV of 128 Kbits/second. It should also be note that there are two types of slice, these types are: a) an intra slice that is encoded without using temporal prediction; and b) an inter slice that is coded using temporal predicted information. The non-uniformity used to adaptively adjust the slice widths is based on the type and size of a MB and the slice widths are adaptively adjusted, relative to a Current Slice Width (CSW) and an Initial Slice Width (ISW) of 600 bits, where initially CSW:=ISW and the slice widths are adaptively adjusted as follows:
1. Whenever a MB is from group (i) (i.e. 16×16, 16×8 or 8×16), then the CSW is reduced by 4% of ISW for a bit rate of less than the BTHV or the CSW is reduced by 8% of ISW for a bit rate equal to or more than the BTHV. This size of MB indicates that the degree of non-uniformity is low.
2. Whenever a MB is from group (ii) (i.e. 8×8), then the CSW is reduced by 8% for a bit rate of less than the BTHV or the CSW is reduced by 10% of ISW for a bit rate equal to or more than the BTHV. This size of MB indicates that the degree of non-uniformity is moderate.
3. Whenever a MB is from group (iii) (i.e. 8×4, 4×8 or 4×4), then the CSW is reduced by 10% of ISW for a bit rate of less than the BTHV or the CSW is reduced by 20% of ISW for a bit rate equal to or more than the BTHV. This size of MB indicates that the degree of non-uniformity is high.
4. Whenever a MB in an inter slice is coded as intra (i.e. group (iv)), then the CSW is reduced by 8% of ISW for a bit rate of less than the BTHV or the CSW is reduced by 10% of ISW for a bit rate equal to or more than the BTHV. This size of MB indicates that the degree of non-uniformity is moderate.
5. Whenever a MB is skipped (i.e. group (v)), then the CSW is increased by 4% of ISW for a bit rate of less than the BTHV or the CSW is increased by 8% of ISW for a bit rate equal to or more than the BTHV. A skipped MB indicates that the degree of non-uniformity is very low.

In each of the above cases, the value of CSW is further limited to fall within a range [MIN_CSW: MAX_CSW]. The values of MIN_CSW and MAX_CSW are selected based on the encoding parameters bit rate, frame size, and frame rate.

From the above, it is apparent that the slice width is adaptively adjusted depending on the bit rate and the degree of non-uniformity that can be low, medium or high. The amount of decrease is correlated with the degree of non-uniformity.

It should also be noted that the indicated macroblock groupings, the indicated ISW, the indicated amount of increase and decrease in CSW, and the indicated BTHV, are all nominal values that is used in the preferred embodiment. These numbers could be appropriately modified without deviating from the central idea in the invention.

The length of the slice width is increased for skipped MBs within some limits since skipped MB's are easier to conceal. The higher decrements (for smaller block size) or increments (for skipped) are used at higher bit rates. The limits MIN_CSW and MAX_CSW can be varied to achieve tradeoff between loss of compression efficiency and concealment error. If the lower limit is increased, the packet size is ensured to be high and gives better compression efficiency, but this would effect the concealment due to larger packets. But if the higher limit is increased then larger packet size results adjacent MB being not available for concealment. The adjusted slices are encoded at block 404 for efficient transmission of video data.

The tradeoff between loss of compression efficiency and improvement in concealment is as follows. The Total Error (TE) after concealment is sum of quantization error and concealment error i.e. if QE is the quantization error and CE is the error after concealment, TE=QE+CE since QE and CE are independent. CE can be improved if adjacent MBs are available for concealment. The concealment error is minimized by having smaller packet size for non-uniform regions. But this increases the loss of compression efficiency since the MV prediction is limited within slice. The tradeoff is having large slice width for uniform regions and smaller slice width for non-uniform regions. The parameters, which will decide the average slice width are slice width decrements/increments and slice width range. By varying these parameters the compression efficiency VS concealment tradeoff can be adjusted.

During decoding, the slice width is decoded independently of the picture content in other slices or regions of picture. The process of reconstruction of a slice is independent of the reconstruction of any other slice in a picture. The slice width provides decoding and reconstruction independence by disabling all forms of prediction, overlap and loop-filtering across slice-boundaries.

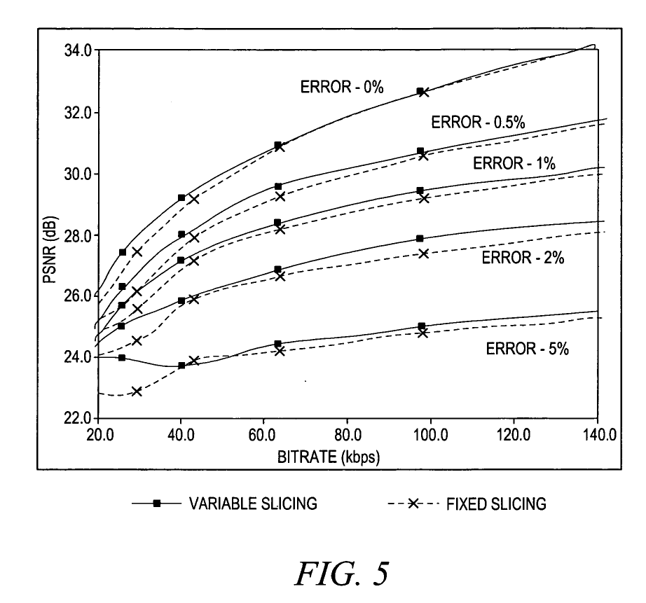

Using the method 400 the below results in FIGS. 5 to 10 were observed in which random packet errors of different percentages were introduced in bit-streams. As only relative quality comparison analyzed, care has been taken to avoid errors in I frames which otherwise would degrade the PSNR. Also in decoding it is assumed that at the end of a frame all lost MBs are concealed using their available neighboring MBs.

Referring to the results of FIG. 5, variable slicing is implemented for Foreman QCIF data with the ISW 600 bits. The performance of variable slicing (variable slice widths) is compared against normal fixed slicing of slice widths fixed at 320 bits to match the PSNR for variable slicing at zero error (an error free channel). It can be observed that the performance (PSNR values) of variable slicing having slice widths selected by the method 400 is better than the fixed slicing in error prone channels.

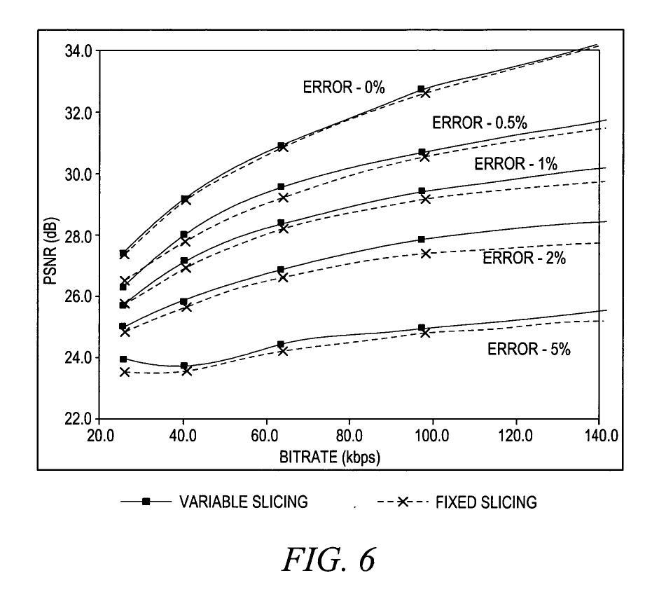

Simulations similar to that of FIG. 5 were repeated to obtain the results of FIGS. 6 to 10 in which bit rates matched for all Quantization Parameters (QPs) in error free conditions (error free channels). This was achieved by using different slice widths for different QPs for fixed slicing. Varying fixed slice width for a particular QP changes the bit rate and can be used to match the bit rate for no error conditions. Though it's not possible practically, this was done for a suitable comparison to determine the benefits of the invention. Hence, in FIG. 6 an apparent improvement in performance can be seen since the variable slicing gives better PSNR than fixed slice widths in error prone environments.

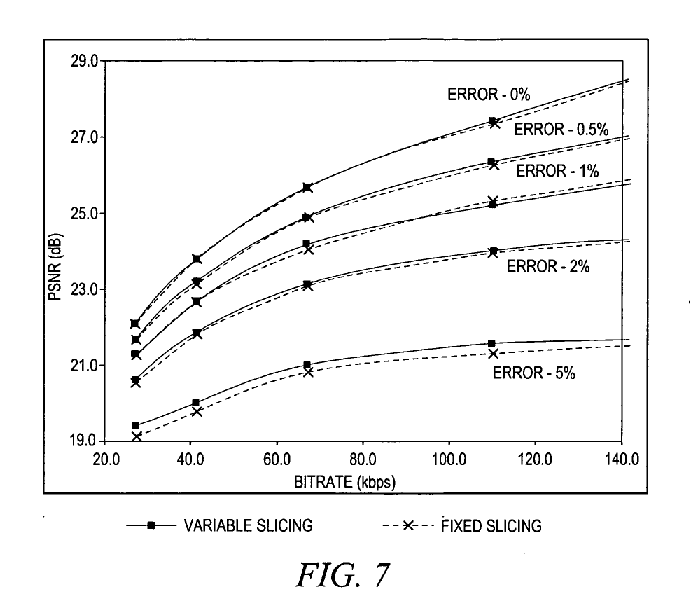

The results in FIG. 7 are for Mobile QCIF data and as shown the performance of variable slicing is better than fixed slicing at lower bit rates for error prone environments. At higher bit rates, the performance is better only for high error rates unlike Foreman. This deviation is due to the effect of tradeoff between compression efficiency and concealment error on the PSNR for the two video sequences which have different characteristics. The Mobile QCIF data sequence contains very few skipped MBs. As slice width decrements are more at higher bit rates than at lower bit rates, the loss of compression efficiency will be more for Mobile sequence (which has relatively more coded MBs) than for Foreman QCIF data. It can be seen that the performance deteriorates a little after 80 kbps for Mobile QCIF data. Also, for Mobile QCIF data at lower packet error rates the effect of loss of compression efficiency on PSNR will be more than that of concealment error. So the performance degrades for low packet errors whereas for Foreman QCIF data the opposite is true

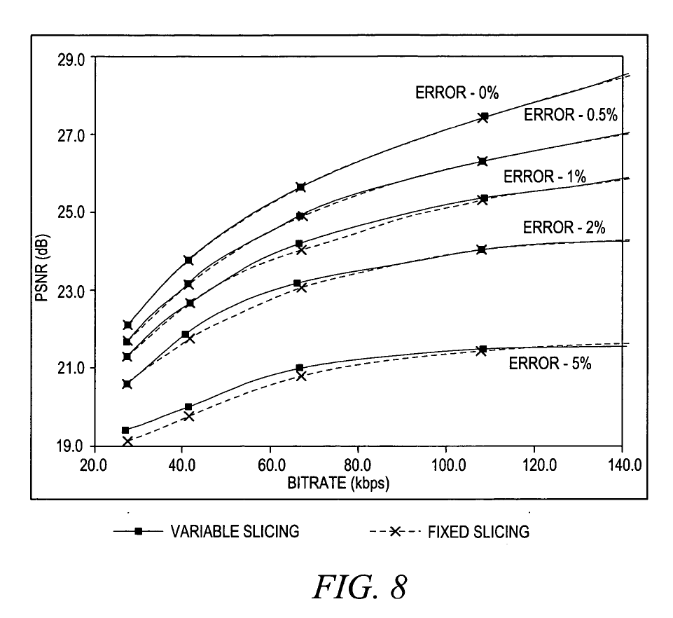

To improve the performance of Mobile at high bit rates and lower error rates, the lower limit on slice width in variable slicing has been increased at high bit rates so as to increase the average slice width. From the results of FIG. 8 it can be deduced that this increase in the average slice width results in better compression efficiency along with improved performance at high bit rates and lower error rates.

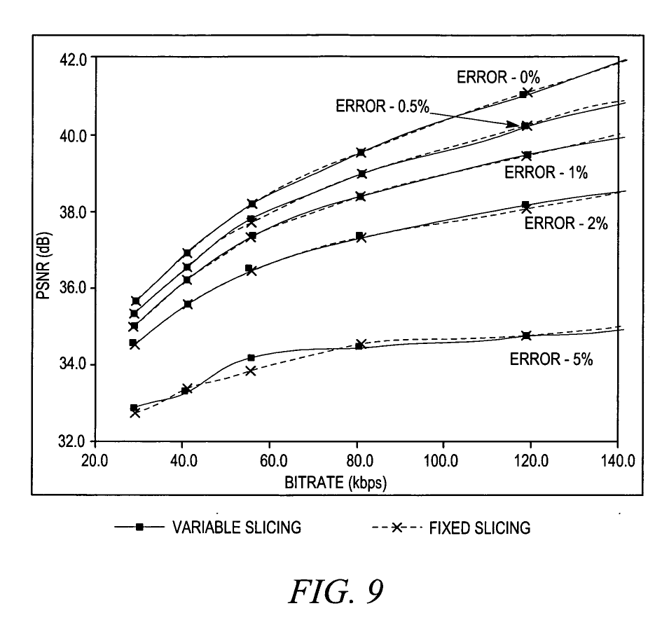

The performance of variable slicing for a Container QCIF data sequence is shown in FIG. 9. The performance is relatively good at low bit rates. At high bit rates, because of large number of skipped blocks, the average size increases. This results in longer packets and poor performance at high error rates.

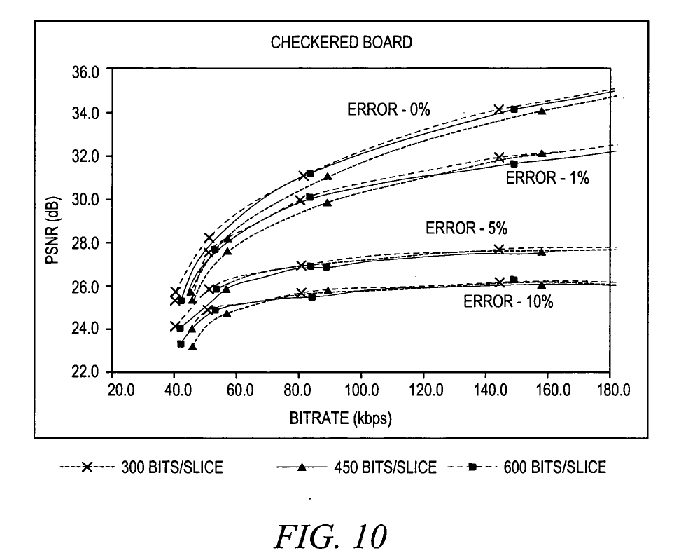

Changing the slice width does not greatly affect PNSR at different error conditions as shown in FIG. 10. Also, it should be noted that the same method 400 can be used when FMO is enabled i.e. the slice width is varied depending upon the content.

Based on the experimental results of FIG. s 5 to 10, the method 400 of choosing slice width based on the non uniformity of the region of the picture gives better performance than that of the normal slicing. The performance depends on the error rate, bit rate and the type of the sequence. For medium motion (medium non-uniform) sequences like Foreman, variable slicing performs better at all bit rates for all error rates, as there is better tradeoff between compression efficiency and concealment error. For high motion (more non-uniform) sequences like Mobile, at lower bit rates performance is better at all error rates and at high bit rates performance is good for high error rates. This is because there is lot of non-uniformity at high bit rates. Hence the average packet size for fixed length decreases. For low motion sequences like Container, performance is good only at low bit rates. Better performance can be achieved by improving the tradeoff between compression efficiency and concealment error. To improve the compression efficiency, the lower limit of the slice width in variable slicing can be increased. To reduce the concealment error the decrements can be increased and this will help in improving performance at high bit rates and high error rates for high motion sequences. Although the method 400 is more suitable for H.264 because of block size selection for both intra and inter frames, it can also be used for other encoders also. The effect may not be as pronounced for MPEG4 when compared to H.264 because of limited choice in block size selection.

In the foregoing specification, the specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. A video encoder comprising:
a transform coder;
an entropy encoder with an input coupled to an output of the transform coder; and
a packetization module having inputs coupled to outputs of the transform coder and entropy coder, wherein in response to receiving data corresponding to a video stream, the transform coder provides transform coefficients and side information that are processed by the entropy coder to provide entropy coded information, and wherein the entropy coded information and side information are processed by the packetization module to provide macroblocks with an adaptively adjusted variable slice width, the slice width being dependent on non-uniformity of content in said video stream.

2. A method for encoding video content comprising:
providing transform coefficients and associated side information for macroblocks forming part of a frame of a video stream;
processing the transform coefficients and associated side information to obtain entropy coded information for the macroblocks; and
Forming slices from the entropy coded information, the slices having slice widths that are adaptively adjusted based upon the non-uniformity of video content of the frame.

3. The method as claimed in claim 2 wherein the degree of non-uniformity of the video content in the frame is determined by the macroblock type, macroblock mode and block mode; wherein the macroblock type is one of intra, inter and skipped; and wherein the macroblock mode is one of 16×16, 16×8, 8×16, and 8×8; and wherein the block mode is one of 8×4, 4×8, and 4×4.

4. The method as claimed in claim 2 wherein said slice width is adaptively adjusted based on the bit rate of the video content.

5. The method as claimed in claim 2 wherein the slice width is adaptively adjusted based on a macroblock mode, block mode and macroblock type.

6. The method as claimed in claim 2, wherein when a macroblock mode is 16×16, 16×8 or 8×16 pixels, then the slice width is selectively reduced.

7. The method as claimed in claim 2 wherein when a macroblock mode is 8×8 pixels, then the lice width is selectively reduced.

8. The method as claimed in claim 2 wherein when a block mode within a macroblock is 8×4, 4×8 or 4×4 pixels, then the slice width is selectively reduced.

9. The method as claimed in claim 2 wherein when a macroblock in an inter slice is coded as intra, then the slice width is selectively reduced.

10. The method as claimed in claim 2 wherein when a macroblock is skipped then the slice width is selectively increased.

11. The method as claimed in claim 2 wherein the slice widths are adjusted based on the macroblock type, macroblock mode and block mode, the macroblock type being one of intra, inter or skipped, the macroblock mode being one of 16×16, 16×8, 8×16, or 8×8 pixels and the block mode being one of 8×4, 4×8, and 4×4 pixels.

12. The method as claimed in claim 2 wherein the slice width is limited by a maximum and minimum value.
